(19) United States
(12) Patent Application Publication
(10) Pub. No.: US 2020/0095470 A1
(43) Pub. Date: Mar. 26, 2020

(54) WATER-DISPERSIBLE SHEET

(71) Applicant: NIPPON PAPER PAPYLIA CO., LTD., Shizuoka (JP)

(72) Inventors: Masaki KISHIMOTO, Tokyo (JP); Yoshiaki ISHINO, Tokyo (JP)

(73) Assignee: NIPPON PAPER PAPYLIA CO., LTD., Shizuoka (JP)

(21) Appl. No.: 16/617,669

(22) PCT Filed: Apr. 9, 2018
(86) PCT No.: PCT/JP2018/014912

§ 371 Date: Nov. 27, 2019

(30) Foreign Application Priority Data
May 30, 2017 (JP) 2017-106188

(51) Int. Cl. C09J 7/29; D21H 15/10; D21H 19/12; D21H 27/00

(52) U.S. Cl. CPC C09J 7/29; D21H 15/10; C09J 2401/006; D21H 27/00; C09J 2400/283; D21H 19/12

(57) ABSTRACT

The purpose of the present invention is to improve the balance between the water dispersibility and the surface barrier property of a water-dispersible sheet having a sealing layer comprising methylcellulose on at least one surface. The water-dispersible sheet with an improved balance between the water dispersibility and the surface barrier property can be obtained by using methylcellulose having a specific viscosity in the sealing layer. Provided is a water-dispersible sheet having a sealing layer comprising methylcellulose on at least one surface of a water-dispersible base paper, wherein the water-dispersible base paper comprises fibrous carboxymethyl cellulose and papermaking fiber with 500 to 750 ml CSF of Canadian standard freeness, the fibrous carboxyalkyl cellulose is alkalized, and the viscosity of a 2% aqueous solution of the methylcellulose measured by a Brookfield viscometer at 20 degree C. is 20-30 cps.

### FIELD OF THE INVENTION

The present invention relates to a water-dispersible sheet with an improved balance between the water dispersibility and the surface barrier property, in which a sealing layer comprising methylcellulose is installed on at least one surface of the water-dispersible sheet.

### BACKGROUND OF THE INVENTION

Water-dispersible paper (also referred to as water-disintegrable paper or water-soluble paper), which is rapidly dispersed in water, is widely used for applications such as filter-wrapping paper of cigarettes, confidential document paper, fishing rod bait bags (Reference 1 etc.).

As such examples, a water-dispersible label, which can be attached to a returnable container and the like, comprising a coating layer, such as a heat-sensitive recording layer or an inkjet recording layer, on one surface so that printing or recording can be performed on the water-dispersible and a water-soluble tacky adhesive layer on the other surface (Reference 2 etc.), a water-dispersible base material comprising a coating layer comprising polyvinyl alcohol and rice starch on one side or both sides of a water-dispersible paper so that printability, water resistance and body strength are improved (Reference 3) and the like are disclosed.

Furthermore, water-dispersible papers comprising a coating layer containing a water-soluble cellulose ether or the like between each coating layer and the water-dispersible paper, in order to achieve both the water dispersibility and the surface strength, are disclosed (References 4-6 etc.).

Reference 1: Japanese Patent Application Public Disclosure No. H09-49188

### Reference 2: Japanese Patent Application Public Disclosure No. 2004-314623

Reference 3: Japanese Patent Application Public Disclosure No. H08-13385

### Reference 4: International Publication WO2012/014970

### Reference 5: Japanese Patent Application Public Disclosure No. 2001-172579

### Reference 6: Japanese Patent Application Public Disclosure No. 2001-279696

### Problems to be Solved by the Invention

As the inventors examined the properties of a water-dispersible sheet (References 4-6 etc.) having a sealing layer comprising a water-soluble cellulose ether such as methyl cellulose installed on a water-dispersible paper (References 1, 4 etc.), which comprises fibrous carboxymethyl cellulose and papermaking fiber, and a tacky adhesive layer installed on the sealing layer, the inventors found a problem of a decrease in the tacky adhesive strength with time (see Comparative Examples 1 to 3 below) due to sinking of the tacky adhesive layer into the paper layer, and the problem needs to be improved.

Therefore, one of the objectives of the present invention is to provide a water-dispersible sheet in which the balance between the water dispersibility and the surface barrier property is improved. In the present invention, the term “surface barrier property” means that, in a structure in which a sealing layer is installed on a base material, when a surface layer is further installed on the sealing layer, the performance of the base material and/or the surface layer does not change (especially, does not deteriorate) by the influence of the materials of the opposite side to the sealing layer. Such a water-dispersible sheet, even when a coating layer such as a tacky adhesive layer is installed, is considered not to have such a problem as a decrease in the properties with time such as sinking of the tacky adhesive layer into the paper layer, while maintaining water dispersibility.

### Means to Solve the Problems

In order to solve the problem, the inventors examined the composition of the sealing layer of the water-dispersible sheet in which the sealing layer was installed on the water-dispersible base paper, which comprises alkalized fibrous carboxymethyl cellulose and papermaking fiber (References 1, 4 etc.).

As a result, the inventors found that the water-dispersible sheet with an improved balance between the water dispersibility and the surface barrier property can be achieved by using methylcellulose with a specific viscosity in the sealing layer, and completed the present invention.

That is, the present invention is a water-dispersible sheet having a sealing layer comprising methylcellulose on at least one surface of a water-dispersible base paper, wherein the water-dispersible base paper comprises fibrous carboxymethyl cellulose and papermaking fiber with 500 to 750 ml CSF of Canadian standard freeness, the fibrous carboxyalkyl cellulose is alkalized, and the viscosity of a 2% aqueous solution of the methylcellulose measured by a Brookfield viscometer at 20 degree C. is 20-30 cps.

### DETAILED DESCRIPTION OF THE INVENTION

The water-dispersible sheet of the present invention comprises a water-dispersible base paper (hereinafter also referred to as “base paper”) and a sealing layer installed thereon. The sealing layer may be installed on one surface or both surfaces of the base paper.

The base paper of the present invention comprises papermaking fibers and fibrous carboxymethyl cellulose.

The content of the papermaking fiber in the base paper of the present invention is preferably 10 to 95% by weight, more preferably 50 to 90% by weight, and further more preferably 60 to 80% by weight.

The papermaking fibers used in the present invention includes wood pulp fibers or non-wood pulp fibers commonly used for papermaking, for example, wood pulp fibers such as softwood Kraft pulp, hardwood Kraft pulp, dissolved pulp, mercerized pulp; non-wood pulp fibers such as flax pulp, Manila hemp pulp, Kenaf pulp; purified cellulose fibers such as lyocell, and the like.

The average fiber length of the water-dispersible papermaking fibers is 0.1 to 5 mm, preferably 0.5 to 3 mm, more preferably 0.8 to 2 mm.

The Canadian standard freeness of the papermaking fiber is 500 to 750 ml CSF, preferably 600 to 720 ml CSF. The Canadian standard freeness is measured according to Japanese Industrial Standard (JIS) P8121-2 2012 (the same shall apply hereinafter). As the beating proceeds (the freeness decreases), fibrillation, cutting and internal swelling of the fibers increase. Therefore, the water dispersibility decreases, while the density, strength and smoothness of the base paper increase.

The base paper of the present invention may have a multi-layer structure (two layers, three layers, etc.) comprising a plurality of layers having different Canadian standard freeness, different types and ratio of papermaking fibers and alkalinized fibrous carboxymethyl cellulose. The basis weight of the base paper of the present invention is usually 10 to 200 g/m² and, in particular, the base paper of the coated paper for printing/recording is usually 50 g/m² or more, preferably 50 to 120 g/m².

The fibrous carboxymethyl cellulose used in the present invention is obtained by carboxymethylating natural cellulose fibers, regenerated cellulose fibers or purified cellulose fibers by a known method, and is water insoluble.

The degree of substitution of carboxymethyl group of the fibrous carboxymethyl cellulose used in the present invention is 0.2 to 1.0, preferably 0.4 to 0.6.

In the present invention, the fibrous carboxymethyl cellulose is alkalized by using an alkalizing agent. By alkalizing the base paper, the water-insoluble fibrous carboxymethyl cellulose in the base paper is converted to a water-soluble fibrous carboxymethyl cellulose salt by a neutralization reaction, then the fibers of the base paper tend to swell and break up in water and the base paper becomes water dispersible.

The alkalizing agent is an aqueous solution of an alkaline compound, and the specific examples thereof include water solutions of alkali metal hydroxides such as sodium hydroxide and potassium hydroxide; carbonates and bicarbonates of alkali metals such as sodium carbonate and sodium bicarbonate; alkaline metal phosphate or hydrogen phosphate, such as sodium hydrogen phosphate; organic acid salts of alkali metals, such as sodium acetate; hydroxides of alkaline earth metals such as calcium hydroxide; ammonia and ammonium salts; amines such as ethanolamine; polyethyleneimine with a molecular weight of 1000 or less; and the like.

The alkalization may be carried out by mixing the alkalizing agent into a stock solution during paper making of base paper, or, after paper making, by spraying the alkalizing agent by using a sprayer, coating by using a coating machine, or transferring the alkalizing agent to the paper stock by using a felt, etc. on which the alkalizing agent is applied, and the like. It can be carried out by any suitable method as appropriate. Further, this alkalization may be performed before forming the sealing layer on the base paper, or after forming the sealing layer on the base paper.

When applying the alkalizing agent on the base paper using a coating machine, the alkalizing agent is applied using a coating machine as an aqueous solution of the above-mentioned alkaline compound or a mixture of the aqueous solution and an aqueous organic solvent compatible with the aqueous solution. The coating machine includes a well-known air knife coater, a bar coater, a roll coater, a blade coater, a curtain coater, a champlex coater, a gravure coater and the like.

In addition, a water-soluble polymer compatible with the aqueous solution may be blended in the aqueous solution of the alkaline compound in order to adjust the viscosity suitable for the coating machine or to prevent the alkaline compound from falling off after drying. The water-soluble polymer includes starch and starch derivatives, cellulose derivatives such as carboxymethyl cellulose salts and the like, alginates, polyacrylates, and the like.

The coating amount of the alkaline compound is preferably at least the neutralization equivalent of the fibrous carboxymethyl cellulose in the base paper, more preferably 1 to 3 times of the neutralization equivalent. When the amount of the alkaline compound is less than the neutralization equivalent, sufficient water dispersibility is difficult to obtain since the water-insoluble fibrous carboxymethyl cellulose remains, and the solubility is reduced greatly since the carboxymethyl celluloses are combined with each other over time. On the other hand, when the amount of the alkaline compound is more than three times of the neutralization equivalent, it is not preferable because the appearance and the quality deteriorates, such as discoloration and strength reduction, occurs due to the influence of the alkaline compound remaining in the substrate.

It is desirable to adjust the amount of the alkaline compound appropriately because the amount of the alkaline compound varies depending on the basic weight of the base paper, the degree of substitution and blending ratio of the fibrous carboxyalkyl cellulose, the type of the alkaline compound to be used, and the like. The amount of the alkaline compound is generally in the range of 0.2 to 70 parts by weight based on 100 parts by weight of the base paper. Furthermore, when the alkaline compound is sodium carbonate, the amount of the alkaline compound is preferably 0.3 to 67 parts by weight, more preferably 2.3 to 20 parts by weight based on 100 parts by weight of the base paper, and, when the alkaline compound is sodium hydroxide, the amount of the alkaline compound is preferably 0.2 to 51 parts by weight, more preferably 1.7 to 15 parts by weight based on 100 parts by weight of the base paper.

In addition, the water holding property of the base paper with respect to aqueous alkali compound solution may be adjusted by adding a water holding agent to the solution. Examples of this water holding agent include starch and starch derivatives, cellulose derivatives such as carboxyalkyl cellulose salts, hydroxyalkyl cellulose and alkyl cellulose, water holding agents of natural polymer such as alginates, xanthan gum and the like, polyacrylates, polyvinylpyrrolidone, gelatin, casein and the like, but the water holding agents are not particularly limited to these.

The sealing layer of the present invention comprises methylcellulose as a main component, and may contain pigments and various additives as necessary.

The viscosity of the methylcellulose used in the present invention is 20-30 cps. This viscosity is the viscosity of a 2% aqueous solution of the methylcellulose measured by a Brookfield viscometer at 20 degree C.

By using methylcellulose with this viscosity for the sealing layer of the present invention, the surface barrier property of the sealing layer can be improved while maintaining the appropriate water dispersibility (water solubility) of the water-dispersible sheet having a sealing layer and a water-dispersible base paper, wherein the water-dispersible base paper comprises alkalized fibrous carboxymethyl cellulose and papermaking fiber.

Starch and carboxymethyl cellulose salt etc. are not suitable for the sealing layer of the present invention. Since starch and carboxymethylcellulose salt etc. have poor film elongation compared to methylcellulose, the surface barrier properties of these are inferior to methylcellulose. Polyvinyl alcohol and modified polyvinyl alcohol, which are commonly used, are also not suitable for the sealing layer. This is because the polyvinyl alcohol film swells in water but is insoluble to water and the film of polyvinyl alcohol with low saponification degree is insolubilized by the alkalized water-dispersible base paper.

Further, the sealing layer of the present invention may contain the abovementioned carboxymethyl cellulose salt as long as the performance is not significantly impaired. The content of the carboxymethyl cellulose salt in the sealing layer is at most 50% by weight, preferably 40% by weight or less.

The pigments that can be used for the sealing layer include, for example, inorganic pigments such as silica, calcium carbonate, clay, kaolin, calcined kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate, magnesium aluminosilicate and the like: organic pigments such as melamine resin, urea-formalin resin, polyethylene powder, nylon powder and the like: and polysaccharide powders such as cellulose powder and carboxymethyl cellulose salt powder with 0.35 or less of substitution degree, and the like.

As the additives used for the sealing layer, various commonly used additives can be used in combination. Such additives include pigment dispersants, antifoaming agents, lubricants, sizing agents, preservatives, wetting agents and the like.

When using a pigment in the sealing layer, the content (solid) of methyl cellulose is usually preferably 5 to 100 parts by weight with respect to 100 parts by weight of the pigment.

The smoothness of the surface of the base material on which the sealing layer is installed is not particularly limited, but generally a highly smooth surface is preferred, and a Yankee dryer contact surface or a calendering treatment surface are preferably used.

The sealing layer is obtained by applying a coating liquid obtained by dispersing and mixing the above-mentioned pigment and other additives to methyl cellulose by using a coating machine and drying by heating with a dryer. The coating amount of the sealing layer is usually 0.5 to 30 g/m², preferably 3 to 15 g/m² as the weight after drying. As the coating machine, an air knife coater, a bar coater, a roll coater, a blade coater, a curtain coater, a champlex coater, and a gravure coater etc. can be cited.

A tacky adhesive layer may be installed on the sealing layer of the water-dispersible sheet of the present invention to provide a water-dispersible label that can be attached to a returnable container or the like.

As the tacky adhesive composing the tacky adhesive layer, a tacky adhesive having water-solubility or water re-dispersibility, particularly a water-soluble acrylic tacky adhesive is suitably used.

Examples of the water-soluble acrylic tacky adhesive include those containing, as a base polymer, those comprise a copolymer comprising alkoxyalkyl acrylate and styrene sulfonate and other copolymerizable monomer, or a copolymer of a carboxyl group-containing vinyl monomer such as (meth) acrylic acid and a hydroxyl group-containing monomer and optionally other copolymerizable monomer, and the like. Examples of the water re-dispersible acrylic tacky adhesive include those containing, as a base polymer, those comprise a copolymer of an alkyl (meth) acrylate ester, a carboxyl group-containing vinyl monomer, a vinyl monomer having an alkoxy group, and optionally other copolymerizable monomer, or a copolymer obtained by copolymerization of carboxylated rosin ester-containing vinyl monomer, carboxyl group-containing vinyl monomer and water soluble vinyl monomer, and the like. The carboxyl group of these copolymers may be in the form of a salt in which a part or the whole thereof is neutralized with an alkali as necessary, in which alkali metal salts, amine salts and alkanolamine salts are preferable as the alkali.

A crosslinking agent may be added to the water-soluble acrylic tacky adhesive in order to adjust the adhesion strength, water solubility or water dispersibility. Such crosslinking agent is not particularly limited, but arbitrary ones can be appropriately selected from those conventionally used as crosslinking agents in acrylic tacky adhesives. Examples the crosslinking agent include, for example, isocyanate crosslinking agent such as 1,2-ethylene diisocyanate, epoxy type crosslinking agent such as diglycidyl ether, melamine resins, urea resins, dialdehydes, methylol polymers, metal chelate compounds, metal alkoxides, metal salts and the like. A conventionally known plasticizer, tacky adhesive, colorant, thickener, defoaming agent, leveling agent, plasticizer, antifungal agent, antioxidant and the like may be added to the acrylic tacky adhesive in order to adjust the properties as necessary and to improve the performance. The plasticizer and the tacky adhesive are preferably water-soluble or water-dispersible. Examples of the plasticizer include polyhydric alcohols such as sugar alcohols, polyether polyols, alkanolamine salts of oxidized rosin, and the like. And examples of the tacky adhesive include alkali metal salts such as rosin, disproportionated rosin and hydrogenated rosin, ammonium salts, polyether esters and the like.

These tacky adhesives may be (i) directly applied on the sealing layer of the base paper, or (ii) applied on the release agent containing surface of the release sheet to form a tacky adhesive layer, which is then adhered to the sealing layer of the base paper to transfer the adhesive layer to the sealing layer of the base paper. In either case, a release sheet may be pasted on the adhesive layer and peeled off at the time of use as desired, in order to prevent unnecessary adhesion at times other than use. The coating amount (solid content) of the tacky adhesive layer formed is about 3 to 60 g/m², preferably about 10 to 50 g/m². When the tacky adhesive coating amount is less than 5 g/m², the formed tacky adhesive sheet is insufficient in tacky adhesiveness. On the other hand, when the tacky adhesive coating amount exceeds 60 g/m², the tacky adhesive easily protrudes during production of the tacky adhesive sheet or in a post-processing step, which is not preferable.

The release sheet is not particularly limited and conventionally known release sheet may be used, for example, paper base materials such as glassine paper, coated paper, cast coated paper; laminated paper obtained by laminating thermoplastic resins such as polyethylene etc. on these base paper materials; or various plastic films such as polyethylene terephthalate, polypropylene, polyethylene and the like, on whose one side or both sides release agent such as silicone resin are applied. The basic weight of the release sheet is not particularly limited, but it is usually about 20 to 120 g/m².

The application of the tacky adhesive may be carried out by a printing method and the tacky adhesive may be applied in a pattern shape excluding an edge portion and the like. And the release sheet used in this case may also be partially coated with a release agent corresponding to the pattern shape of the tacky adhesive.

Arbitrary coating layers such as thermosensitive recording layer or inkjet recording layer may be installed on the water-dispersible sheet of the present invention, depending on the application. This coating layer is preferably installed on the sealing layer of the water-dispersible sheet. Moreover, when a tacky adhesive layer is formed on the sealing layer of the water-dispersible sheet as described above, this coating layer may be installed on the opposite surface to the tacky adhesive layer.

The coating layer in the present invention may be a single layer or a multilayer as long as it is formed by coating and drying aqueous coating materials, and the coating method is not limited. In addition, the components of the coating layer may be appropriately chosen from those suitable for the coating or printing method (offset printing, gravure printing, inkjet printer, thermal printer, laser beam printer, etc.).

### EXAMPLES

The following Examples illustrate the present invention, but the Examples are not intended to limit the scope of the present invention. The viscosities are those measured by Brookfield viscometer at 20 degree C. In the following description, the terms parts and % indicate parts by weight and weight %, respectively.

### EXAMPLE

A hand-made paper of a single layer sheet with 60 g/m² of basic weight was prepared using a papermaking material, which comprises 70% by weight of a pulp beaten to 620 ml CSF of Canadian standard freeness and 30% by weight of a fibrous carboxymethyl cellulose (hereinafter referred to as “CMC”, Degree of etherification (DS) is 0.43), wherein the pulp comprises hardwood bleached kraft pulp and softwood bleached kraft pulp. Then a base paper was prepared by applying an aqueous solution with 2.5% by weight of sodium carbonate (soda ash light manufactured by Tokuyama Corporation) on the hand-made paper by a size press method.

Then a coating solution (The viscosity measured by Brookfield viscometer was 365 cps.) containing 4% by weight of methylcellulose (Marpolose M-25 manufactured by Matsumoto Yushi-Seiyaku Co., Ltd., the viscosity of 2 wt % aqueous solution was 26 cps) was applied on the surface of the base paper using a Mayer bar so that the bone-dry deposit is 2 g/m², and was dried to form a sealing layer. Then a water-dispersible sheet was obtained.

A tacky adhesive coating solution with the following formulation was prepared.

### <Tacky Adhesive Coating Solution>

Water-soluble acrylic adhesive (VIGteQnos Co., Ltd., trade name “Riki-Dyne AR-2410”, solid content 42 wt %) 100 parts
Crosslinking agent (VIGteQnos Co., Ltd., trade name “Sunpasta HD-5013”) 0.1 parts

This tacky adhesive coating solution was applied on the release treated surface of a commercially available release sheet, which is coated with a silicone release agent, with an amount (in solid) of 25 g/m² then was dried to form a tacky adhesive layer on the release sheet. This tacky adhesive layer on the release sheet was then adhered to the sealing layer of the water-dispersible sheet to prepare a water dispersible sheet.

### Example 2

A water-soluble sheet was prepared in the same manner as described in Example 1 except using a papermaking material, which comprises 95% by weight of the pulp and 5% by weight of the fibrous CMC.

### Example 3

A water-soluble sheet was prepared in the same manner as described in Example 1 except using a papermaking material, which comprises 10% by weight of the pulp and 90% by weight of the fibrous CMC.

### Comparative Example 1

A water-soluble sheet was prepared in the same manner as described in Example 1 except using a coating solution (The viscosity was 420 cps.) containing 2% by weight of methylcellulose (Marpolose M-400 manufactured by Matsumoto Yushi-Seiyaku Co., Ltd., the viscosity of 2 wt % aqueous solution was 420 cps) when preparing the sealing layer.

### Comparative Example 2

A water-soluble sheet was prepared in the same manner as described in Example 1 except using a coating solution (The viscosity was 305 cps.) containing 1% by weight of methylcellulose (Marpolose M-4000 manufactured by Matsumoto Yushi-Seiyaku Co., Ltd., the viscosity of 2 wt % aqueous solution was 3760 cps) when preparing the sealing layer.

### Comparative Example 3

A water-soluble sheet was prepared in the same manner as described in Example 1 except using a coating solution (The viscosity was 300 cps.) containing 2% by weight of hydroxypropyl-methylcellulose (Marpolose 65MP400 manufactured by Matsumoto Yushi-Seiyaku Co., Ltd., the viscosity of 2 wt % aqueous solution was 300 cps) when preparing the sealing layer.

### Comparative Example 4

A water-soluble sheet was prepared in the same manner as described in Example 1 except using a coating solution (The viscosity was 215 cps.) containing 10% by weight of PVA (Nippon Synthetic Chemical Industry Co., Ltd., Gohsenol KP-08R, the viscosity of 2 wt % aqueous solution was 7 cps) instead of the coating solution with methylcellulose when preparing the sealing layer.

### Comparative Example 5

A water-soluble sheet was prepared in the same manner as described in Example 1 except using the papermaking material comprising solely the pulp.

### Comparative Example 6

A water-soluble sheet was prepared in the same manner as described in Example 1 except not installing the sealing layer.

The prepared water-dispersible sheets were evaluated as follows (1) at initial stage and (2) after stored for seven days at 40 degree C.×85% RH.

1) Solubility in water

Five test pieces of 3 cm square were prepared from the sample which had been conditioned in an atmosphere of 23 degree C. and 50% RH for 24 hours or more. Then 300 ml of deionized water was placed in a 300 ml beaker, and one piece of the above test piece, from which the release sheet was peeled off, was put in the beaker while stirring at 650 rpm with a stirrer. The time required for the test piece to break to two or more pieces was measured with a stopwatch, and the average of five measurements was taken as the dispersion time (seconds). The shorter the dispersion time, the better the dispersion.

The solubility was evaluated according to the following criteria:
Good: The dispersion times for both (1) initial and (2) after storage are less than 30 seconds, and the dispersion times of (2) after storage is less than twice the dispersion times for (1) initial.
Fair: The dispersion times for either of (1) initial and (2) after storage is 30 seconds or more, and the dispersion times of (2) after storage is less than twice the dispersion times for (1) initial.
Poor: The dispersion times for either of (1) initial and (2) after storage is 30 seconds or more, and the dispersion times of (2) after storage is equal to or more than twice the dispersion times for (1) initial.

If the dispersion times for (2) after storage is less than twice the dispersion times for (1) initial, the surface barrier property of the sealing layer is good enough.

### 2) Tacky Adhesive Strength

According to Japanese Industrial Standard (JIS) Z0237, three test pieces of 25 mm×250 mm were cut out from each of the water-dispersible sheet, and the tacky adhesive surface of the test piece with the release paper peeled off was put on a stainless steel plate (100×150 mm), then a rubber roller weighing 3 kg was reciprocated twice on the test piece.

The stainless steel plate was clamped by the lower chuck of a tensile tester, while one end of the tacky adhesive test piece was clamped by the upper chuck of the tensile tester. Then a 180 degree peel test was conducted at a tensile speed of 300 mm/min to obtain the tacky adhesion strength (g/25 mm).

The change in the tacky adhesive strength was evaluated according to the following criteria:
Good: The tacky adhesive strength for (2) after storage is 70% or more of the tacky adhesive strength for (1) initial.
Poor: The tacky adhesive strength for (2) after storage is less than 70% of the tacky adhesive strength for (1) initial.

If the tacky adhesive strength for (2) after storage is 70% or more of the tacky adhesive strength for (1) initial, the surface barrier property of the sealing layer is good enough.

The composition of the water-dispersible sheets and the evaluation results are shown in the Table 1.

TABLE 1

| | | coating solution for | | | | | | | |
|---|---|---|---|---|---|---|---|---|---|
| | | sealing layer | | (1) initial | | (2) after storage | | evaluation result | |
| | | | viscosity | | tacky adhesive | | tacky adhesive | solubility | tacky |
| | | | (cps) 2%, | dispersion | strength | dispersion | strength | in | adhesive |
| | base paper | component | 20° C. | time (sec) | (g/25 mm) | time (sec) | (g/25 mm) | water | strength |
| Example 1 | papermaking fiber70%/ | methylcellulose | 26 | 11 | 1551 | 19 | 1118 | good | good |
| | CMC30% | | | | | | | | |
| Example 2 | papermaking | methylcellulose | 26 | 8 | 1456 | 12 | 1056 | good | good |
| | fiber10%/CMC90% | | | | | | | | |
| Example 3 | papermaking | methylcellulose | 26 | 21 | 1620 | 25 | 1203 | good | good |
| | fiber95%/CMC5% | | | | | | | | |
| Comparative | papermaking fiber70%/ | methylcellulose | 420 | 13 | 1401 | 21 | 602 | good | poor |
| Example 1 | CMC30% | | | | | | | | |
| Comparative | papermaking fiber70%/ | methylcellulose | 3760 | 12 | 1423 | 18 | 528 | good | poor |
| Example 2 | CMC30% | | | | | | | | |
| Comparative | papermaking fiber70%/ | hydroxypropyl- | 300 | 11 | 1390 | 20 | 498 | good | poor |
| Example 3 | CMC30% | methylcellulose | | | | | | | |
| Comparative | papermaking fiber70%/ | PVA | 7 | 14 | 1560 | >300 | 1201 | poor | good |
| Example 4 | CMC30% | | | | | | | | |
| Comparative | papermaking fiber only | methylcellulose | 26 | 36 | 1635 | 44 | 1296 | fair | good |
| Example 5 | | | | | | | | | |
| Comparative | papermaking fiber70%/ | — | — | 10 | 1250 | 12 | 364 | good | poor |
| Example 6 | CMC30% | | | | | | | | |

1. A water-dispersible sheet having a sealing layer comprising methylcellulose on at least one surface of a water-dispersible base paper, wherein the water-dispersible base paper comprises fibrous carboxymethyl cellulose and papermaking fiber with 500 to 750 ml CSF of Canadian standard freeness, the fibrous carboxymethyl cellulose is alkalized, and the viscosity of a 2% aqueous solution of the methylcellulose measured by a Brookfield viscometer at 20 degree C. is 20-30 cps.

2. The water-dispersible sheet of claim 1, wherein the content of the papermaking fiber in the water-dispersible base paper is 10 to 95% by weight.

3. The water-dispersible sheet of claim 1, wherein the content of the papermaking fiber in the water-dispersible base paper is 50 to 90% by weight.

4. The water-dispersible sheet of claim 1, wherein a tacky adhesive layer is installed on the sealing layer.

5. The water dispersible sheet of claim 2, wherein a tacky adhesive layer is installed on the sealing layer.

6. The water dispersible sheet of claim 3, wherein a tacky adhesive layer is installed on the sealing layer.
